(19) United States
(12) Patent Application Publication
(10) Pub. No.: US 2016/0011539 A1
(43) Pub. Date: Jan. 14, 2016

(54) IMAGE FORMING APPARATUS

(71) Applicant: CANON KABUSHIKI KAISHA, Tokyo (JP)

(72) Inventors: Tomohito Ishida, Saitama-shi (JP); Tetsuya Atsumi, Tokyo (JP); Kenta Kubo, Kamakura-shi (JP); Megumi Uchino, Tokyo (JP); Shunichi Takada, Soka-shi (JP)

(21) Appl. No.: 14/790,201

(22) Filed: Jul. 2, 2015

(30) Foreign Application Priority Data
Jul. 11, 2014 (JP) 2014-143303

(51) Int. Cl. G03G 15/06

(52) U.S. Cl. CPC G03G 15/065

(57) ABSTRACT

An image forming apparatus includes: an image bearing member; an electric potential sensor which detects electric potential of a toner image; a density sensor which acquires information of a density of the toner image; and a controller which controls contrast electric potential and the AC bias based on a result of the detection of the density sensor and a predetermined target value, wherein the controller decreases the development contrast, and increases the AC bias, when a charging electric potential difference, which is a potential difference between a potential of a predetermined toner image developed by the development device on the image bearing member and the DC bias applied to the development device when the predetermined toner image is developed, increases from a first predetermined value to a second predetermined value;

### BACKGROUND OF THE INVENTION

1. Field of the Invention

The present invention relates to an image forming apparatus including: an image bearing member; a development portion that develops an electrostatic image disposed on the surface of the image bearing member using a development bias; an electric potential sensor that detects the toner electric potential of a developing toner image according to the development portion; and a controller that changes the toner applied amount based on a result of the detection acquired by the electric potential sensor.

2. Description of the Related Art

In Japanese Patent Laid-Open No. 2001-222140, a technology for measuring the electric potential of the surface of an image bearing member after development and changing the toner density or the development contrast of developer based on a result of the measurement has been disclosed. According to such a configuration, the toner applied amount can be controlled.

However, room for further improvement has been found after the consideration of the invention disclosed in Japanese Patent Laid-Open No. 2001-222140, which will be described hereinafter.

FIG. 11 is a schematic diagram that illustrates relation among charging electric potential Vd, a development DC bias Vdc, development contrast Vcont, and exposure portion electric potential Vl. In FIG. 11, the charging electric potential Vd is the electric potential of a white background portion, and the exposure portion electric potential Vl is the electric potential of a solid portion. The development contrast Vcont is an electric potential difference between the development DC bias Vdc and the exposure portion electric potential Vl. Based on the schematic diagram illustrated in FIG. 11, states illustrated in FIGS. 12A to 15D to be described hereinafter will be considered.

FIGS. 12A and 12B are schematic diagrams that illustrate an example in which the development contrast Vcont is changed so as to increase an applied amount of toner by changing the exposure portion electric potential Vl in an initial state of developer. In each of FIGS. 12A and 12B, an upper end of a portion that is painted black represents toner electric potential Vtoner (this applies the same in FIGS. 13A to 15D to be described later).

As illustrated in FIG. 12A, in the initial state of developer, the developability is excellent, and the development process proceeds until the toner electric potential after development is equal to the development DC bias. As illustrated in FIG. 12B, as the development contrast increases, the toner applied amount increases that much. In addition, similarly, also in a case where the toner electric potential after development is equal to the development DC bias, and the toner applied amount changes as the charging amount of the toner is changed, it is effective to correct the toner applied amount by changing the development contrast.

FIGS. 13A and 13B are schematic diagrams that illustrates an example in which, in a degraded state of developer, by changing the exposure portion electric potential Vl, the development contrast Vcont changes but the toner applied amount does not increase.

As illustrated in FIG. 13A, in the degraded state of the developer, there is an electric potential difference between the toner electric potential Vtoner after development and the development DC bias Vdc. As illustrated in FIG. 13B, even when the development contrast increases, only an electric potential difference between the toner electric potential Vtoner after development and the development DC bias Vdc is increased, but the toner applied amount is not increased. The reason for this is that an adhesive force between carriers and toner increases according to the degradation of the developer, and it becomes difficult for the toner to be taken off from the carriers. This is a point to be described as being insufficient even when the development contrast is changed as in the technology described in Japanese Patent Laid-Open No. 2001-222140.

FIGS. 14A, 14B, 14C, and 14D are schematic diagrams that illustrate the process of increasing a development AC bias in a degraded state of developer. With reference to FIGS. 14A to 14D, a control method of a case where the toner applied amount is not increased even when the development contrast is increased in the degraded state of the developer illustrated with reference to FIGS. 13A and 13B will be described. As illustrated in FIG. 14A, in the degraded state of the developer, there is an electric potential difference between the toner electric potential Vtoner after development and the development DC bias Vdc. A development AC bias at this time is as illustrated in FIG. 14B.

In such a case, since it becomes difficult for the toner and the carriers to be taken off each other, as illustrated in FIG. 14D, the development AC bias is set to be high, and the toner and the carriers are taken off from each other. As a result, as illustrated in FIG. 14C, the toner electric potential Vtoner is raised up to electric potential that is at the same level as that of the development DC bias Vdc.

FIGS. 15A, 15B, 15C, and 15D are diagrams that illustrate the process of increasing the development AC bias in the initial state of developer. In case of developer having good developability before long-time use, as illustrated in FIG. 15A, even when the development AC bias is increased from that illustrated in FIG. 15B to that illustrated in FIG. 15D, as illustrated in FIG. 15C, the toner electric potential Vtoner after development is at the same level as that of the development DC bias Vdc. For this reason, the development electric field does not work anymore, and the toner applied amount is not increased. In such a case, as in the conventional case, the toner applied amount is adjusted according to a change in the development contrast.

As described above, even when the development contrast Vcont is increased in a “state of bad developability”, not only the toner applied amount is sufficiently increased, but an electric potential difference between the development DC bias Vdc and the toner electric potential Vtoner after development increases to cause various negative effects.

More specifically, as illustrated in FIG. 16, in an image area in which a solid portion and a halftone portion are adjacent to each other, a phenomenon in which toner to be attached to the halftone portion is attracted to the solid portion so as to be an void image, a so-called “void image” occurs.

FIGS. 17A and 17B are schematic diagrams that illustrate relation among the charging electric potential Vd, the development DC bias Vdc, the development contrast Vcont, and the exposure portion electric potential Vl, a diagram of the development AC bias, and the schematic diagrams that illustrate the charge state of carriers and the appearance of an electric field between the charging electric potential and the toner electric potential. FIG. 17A is a diagram of a case where the toner electric potential and the DC bias are the same, and FIG. 17B is a diagram of a case where an electric potential difference is generated between the toner electric potential and the development DC bias.

When the state illustrated in FIG. 17A transits to the state illustrated in FIG. 17B, an electric potential difference is generated between the toner electric potential and the development DC bias. In that case, also in the process in which development ends in a development nip, as illustrated in FIG. 17B, a development progressing electric field is continuously applied in a direction denoted by an arrow, and a negative effect in which electric charge is injected to a development carrier, and the carrier is developed together with toner, so-called “carrier attachment” may easily occur. When a silicon (aSi) drum having a high dielectric constant or a photoreceptor having a small film thickness is used, the static capacitance of the image bearing member is high, and it is difficult for toner electric charge to bury the development contrast electric potential, whereby such a negative effect becomes serious.

It is effective for controlling the toner applied amount to increase the development contrast when the toner is in the initial state. However, there are also cases where it is not sufficient to only increase the development contrast when the developer is in the degraded state as in Japanese Patent Laid-Open No. 2001-222140.

In addition, it is effective for controlling the toner applied amount to increase the development AC bias when the toner is in the degraded state. However, as cases different from that disclosed in Japanese Patent Laid-Open No. 2001-222140, there are also cases where it is not sufficient to only increase the development AC bias when the developer is in the initial state.

### SUMMARY OF THE INVENTION

The present invention is in view of the above-described situations, and it is desirable to provide an image forming apparatus capable of setting contrast electric potential and a development AC bias so as to secure a toner applied amount better than that of a conventional case also in a case where developer is in a degraded state or a case where the developer is in an initial state.

An image forming apparatus includes: an image bearing member which bears an image; a development device which develops a latent image formed on the image bearing member; a bias applying portion which applies a DC bias and an AC bias to the development device; an electric potential sensor which detects electric potential of a toner image formed on the image bearing member; a density sensor which acquires information relating to a density of the toner image; and a controller configure to control a development contrast which is a potential difference between a potential of a image area on the image bearing member and the DC bias based on a result of the detection acquired by the density sensor, and control the AC bias based on the result of the detection acquired by the density sensor; wherein said controller decreases the development contrast, and increases the AC bias, when a charging electric potential difference, which is a potential difference between a potential of a predetermined toner image developed by the development device on the image bearing member and the DC bias applied to the development device when the predetermined toner image is developed, increases from a first predetermined value to a second predetermined value;

An image forming apparatus includes: an image bearing member which bears an image; a development device which develops a latent image formed on the image bearing member; a bias applying portion which applies a DC bias and an AC bias to the development device; an electric potential sensor which detects electric potential of a toner image formed on the image bearing member; a density sensor which acquires information relating to a density of the toner image; and a controller configure to control a development contrast between potential of a image area on the image bearing member and the DC bias based on a result of the detection acquired by the density sensor, and control the AC bias based on the result of the detection acquired by the density sensor, wherein said controller increases a ratio of the AC bias to the development contrast, when a charging electric potential difference, which is potential difference between potential of a predetermined toner image developed by the development device on the image bearing member and the DC bias applied to the development device when the predetermined toner image is developed, increases from a first predetermined value to a second predetermined value;

Further features of the present invention will become apparent from the following description of exemplary embodiments with reference to the attached drawings.

### BRIEF DESCRIPTION OF THE DRAWINGS

FIG. 1 is a cross-sectional view of an image forming apparatus according to Embodiment 1.

FIG. 2 is a block diagram of internal devices of an apparatus main body.

FIG. 3 is a flowchart that illustrates a control process of a controller.

FIGS. 4A and 4B illustrate a DC/AC correction voltage table and a DC/AC correction ratio table.

FIG. 5 is a table in which good (◯), O.K. (Δ), or bad (x) is determined for each of an applied amount, a void image, carrier attachment, small-point character reproducibility, and highlight area granularity.

FIG. 6 is a cross-sectional view of an image forming apparatus according to Embodiment 2.

FIG. 7 is a block diagram of a controller.

FIG. 8 is a block diagram of an image forming apparatus according to Embodiment 5.

FIG. 9 is a flowchart that illustrates a control process of a controller.

FIG. 10 is a DC/AC correction ratio table.

FIG. 11 is a schematic diagram that illustrates relation among charging electric potential, a development DC bias, development contrast, and exposure portion electric potential.

FIGS. 12A and 12B are schematic diagrams that illustrate an example in which development contrast is changed to increase a toner applied amount by changing the exposure portion electric potential in the initial state of developer.

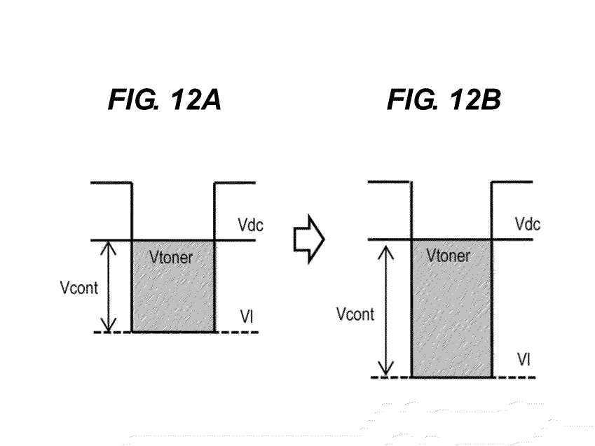

FIGS. 13A and 13B are schematic diagrams that illustrate an example in which the development contrast is changed, but the toner applied amount is not increased by changing the exposure portion electric potential in a degraded state of developer.

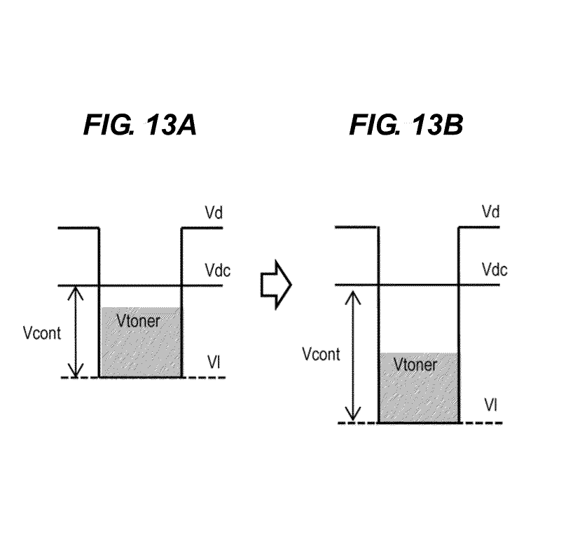

FIGS. 14A to 14D are schematic diagrams that illustrate the process of increasing a development AC bias in the degraded state of the developer.

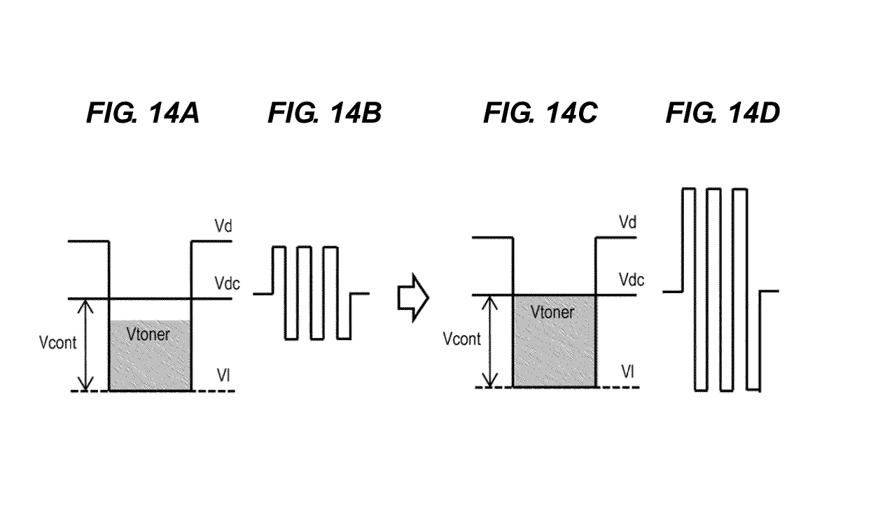

FIGS. 15A to 15D are schematic diagrams that illustrate the process of increasing the development AC bias in the initial state of the developer.

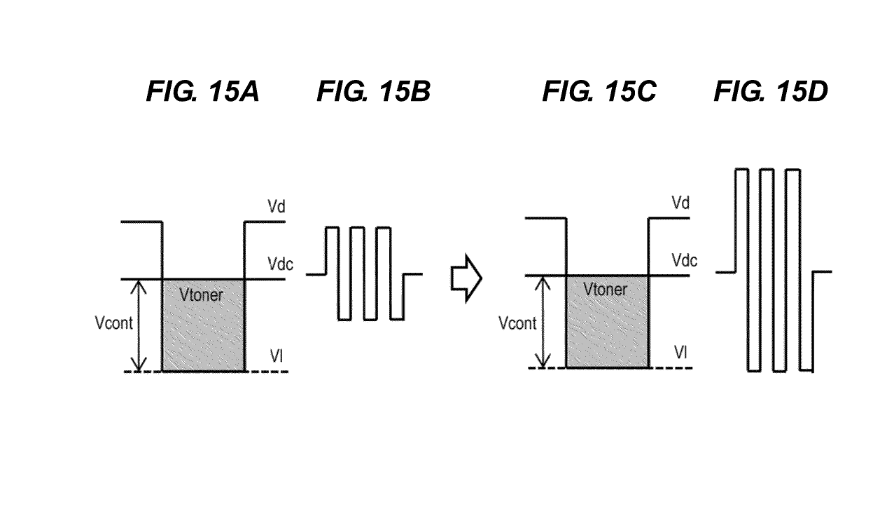

FIG. 16 is a diagram that illustrates a phenomenon in which a “void image” is generated.

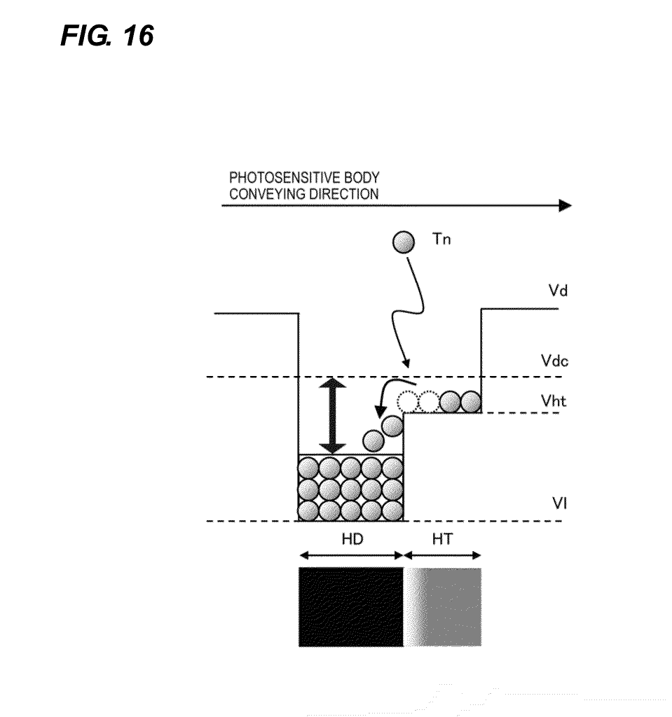

FIGS. 17A and 17B are diagrams that illustrate an occurrence of a negative effect called “carrier attachment”.

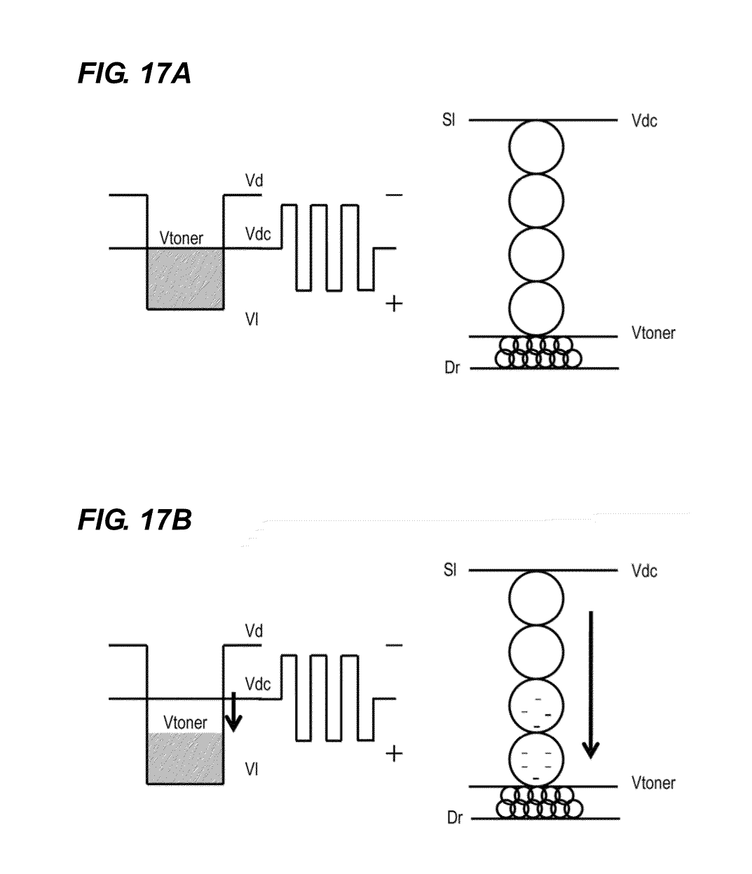

### DESCRIPTION OF THE EMBODIMENTS

Hereinafter, embodiments of the present invention will be described as examples in detail with reference to the drawings. However, the dimension, the material, the shape, the relative position, and the like of each of constituent components described in the embodiments are appropriately changed depending on the configuration of an apparatus to which the invention is applied or various conditions, and thus, the scope of the invention is not intended to be limited thereto unless otherwise described.

### Embodiment 1

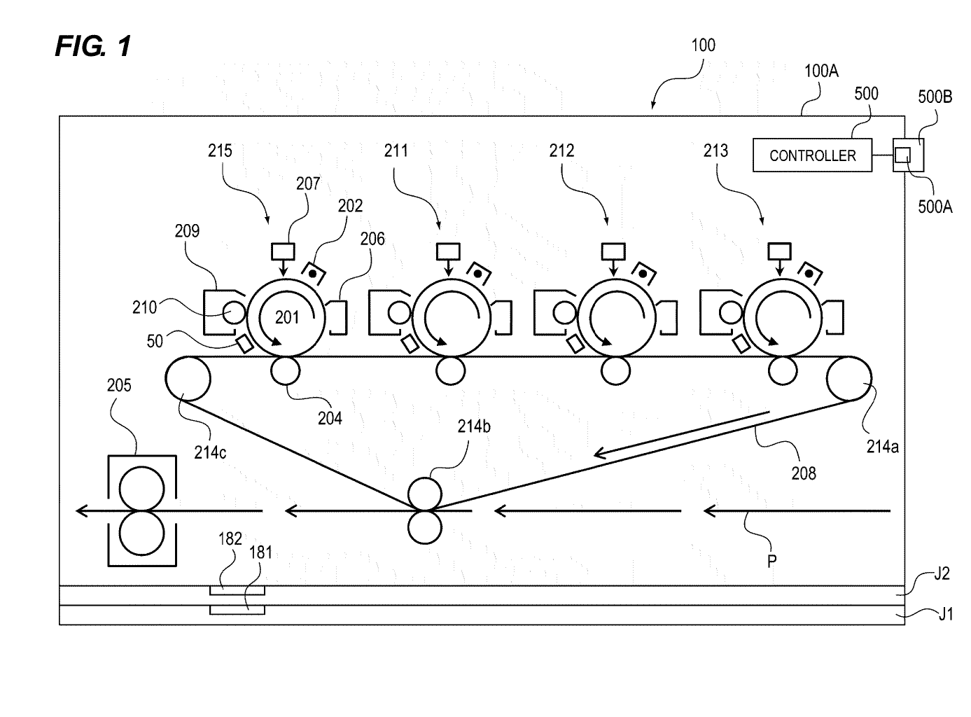

FIG. 1 is a cross-sectional view of an image forming apparatus 100 according to Embodiment 1. As illustrated in FIG. 1, the image forming apparatus 100 includes an apparatus main body 100A. Inside the apparatus main body 100A, a photosensitive drum 201 as an “image bearing member” is arranged. On the periphery of the photosensitive drum 201, a charging device 202, an exposure device 207, a development device 209, and a transfer roller 204 are arranged. The development device 209 as a “development portion” can develop an electrostatic image formed on the surface of the photosensitive drum 201 using a development bias acquired by superimposing a development AC bias on a development DC bias Vdc. An image forming portion is assumed to include at least the photosensitive drum 201.

Here, there are four image forming portions including a cyan image forming portion 215, a magenta image forming portion 211, a yellow image forming portion 212, and a black image forming portion 213. Inside the apparatus main body 100A, a controller 500 that controls driving of internal devices is arranged. In addition, an electric potential measuring device 50 is arranged on a downstream side of the development device 209 in the rotation direction of the photosensitive drum 201 above an intermediate transfer belt 208. The electric potential measuring device 50 as an “electric potential sensor” measures toner electric potential Vtoner of a toner image formed on the surface of the photosensitive drum 201 that has been developed by the development device 209.

The configuration of the cyan image forming portion 215 is similarly employed for the magenta image forming portion 211, the yellow image forming portion 212, and the black image forming portion 213 except for the color of toner.

On the lower side of the photosensitive drum 201, the intermediate transfer belt 208 is arranged. The intermediate transfer belt 208 is suspended on rollers 214a, 214b, and 214c. In addition, a fixing device 205 is arranged on the left obliquely lower side of the intermediate transfer belt 208.

In a lower part of the apparatus main body 100A, a plurality of cassettes J1 and J2 as “housing portions” housing sheets P is arranged. When sheets P are housed in the cassettes J1 and J2, type sensors 181 and 182 detect the types of sheets P disposed inside the cassettes J1 and J2, and profiles of the sheets P are formed by the controller 500. In other words, the controller 500 sets development contrast that is necessary on the photosensitive drum 201 corresponding to each of the sheets P disposed inside the cassettes J1 and J2 by using the type sensors 181 and 182.

The controller 500 controls driving of internal devices of the apparatus main body 100A such as the photosensitive drum 201.

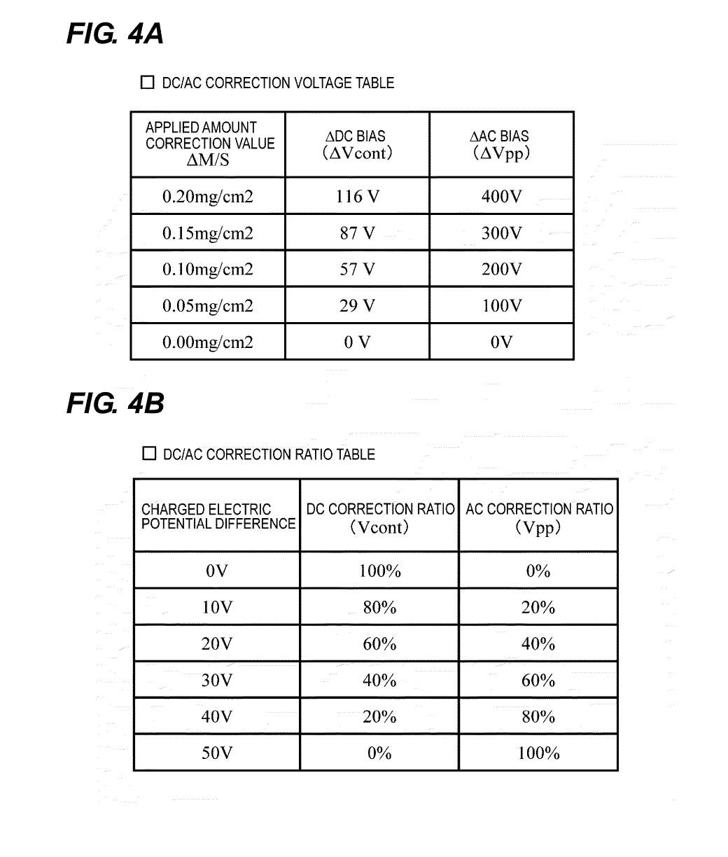

Particularly, in the present invention, the following control process executed by the controller 500 has features. The controller 500 executes the control process as below in a case where an electric potential difference between a development DC bias, which is set when a toner image is formed, and toner electric potential is a second predetermined value (a large charging electric potential difference illustrated in FIG. 4B) larger than a first predetermined value than in a case where the electric potential difference is the first predetermined value (small charging electric potential illustrated in FIG. 4B).

The controller 500 corrects the development contrast (contrast electric potential) and a development AC bias (to be described later) such that the correction ratio of the development AC bias with respect to the correction ratio of the development contrast (contrast electric potential) increases. In addition, the development contrast Vcont (contrast electric potential) is changed by changing at least one of the development DC bias Vdc or the exposure portion electric potential Vl.

The operation of the image forming apparatus 100 will now be described. The surface of the photosensitive drum 201 is uniformly charged by the charging device 202, an electrostatic image is formed by the exposure device 207, and a developer image is formed using developer by the development device 209. Meanwhile, a sheet P housed in one of the cassettes J1 and J2 is conveyed to a nip portion of the photosensitive drum 201 and the transfer roller 204 through a plurality of rollers and the like. Here, the developer image formed on the surface of the photosensitive drum 201 is transferred onto the sheet P. The Sheet P onto which the developer image has been transferred is conveyed to the fixing device 205, the developer image is fixed to the sheet P, and then, the sheet P is discharged to the outside of the apparatus main body 100A.

Here, an image generation process executed by the image forming portion will be described as an example by using numerical values. However, the numerical values are merely an example. When a user instructs an operation portion to form an image for image formation for a sheet P, an output signal thereof is transmitted to the controller 500. Then, the photosensitive drum 201 (OPC drum) is rotated. The charging device 202 (corona charger) uniformly charges the surface of the photosensitive drum 201 with charging electric potential Vd of −500 V. The exposure device 207 executes an exposure process such that an exposure portion of the photosensitive drum 201 has electric potential of −150 V, thereby forming an electrostatic image.

As the developer, two-component developer including nonmagnetic toner charged with negative polarity and a magnetic carrier is used. As the development bias, a rectangular wave bias having a frequency of 6 kHz is used, the development DC bias is set to −350 V, and the development AC bias is set to 1200 V. A gap between a development sleeve 210 included in the development device 209 and the photosensitive drum 201 is set to 300 μm.

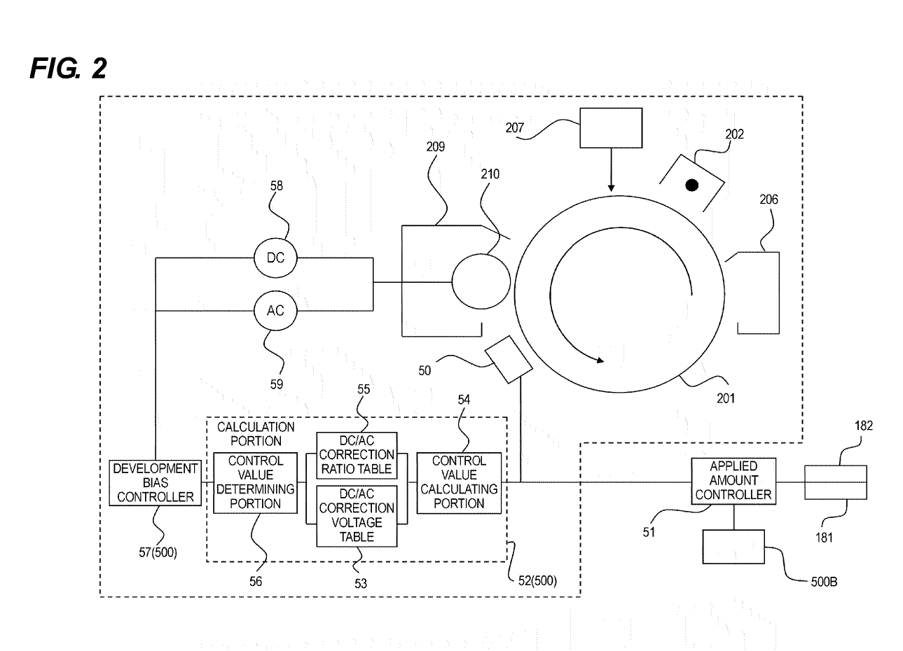

FIG. 2 is a block diagram of internal devices of the apparatus main body 100A. On the outside of the apparatus main body 100A, an external device such as a print server is arranged at predetermined timing during the image generation process. The external device includes an applied amount controller 51 illustrated in FIG. 2. Inside the cassette J1, a coated sheet is housed, and the type sensor 181 detects the coated sheet. Inside the cassette J2, a rough sheet is housed, and the type sensor 182 detects the rough sheet. The user changes a setting from the coated sheet used in the previous time to the rough sheet to be used next time by using a setting portion 500B (see FIG. 1).

The applied amount controller 51 transmits, based on the setting information of the setting portion 500B, information of a toner applied amount of 0.45 mg/cm² that is necessary (defined) for the coated sheet and a toner applied amount of 0.55 mg/cm² that is necessary (defined) for the rough sheet, which is stored inside, and change information representing that the sheet type is changed from the coated sheet to the rough sheet to the calculation portion 52. In addition, the applied amount controller 51 sets a toner density of the photosensitive drum 201 based on the sheet type and a setting of an image quality mode.

The calculation portion 52 changes the applied amount based on a control signal received from the applied amount controller 51. Here, when the sheet P is changed from the coated sheet to the rough sheet, the applied amount that has been 0.45 mg/cm² is change to 0.55 mg/cm². The reason for this is that, in a sheet of which surface roughness is large, toner penetrates into fibers of the sheet, and sufficient color development cannot be acquired, and thus, by increasing the toner applied amount, desired color reproduction can be realized.

The controller 500 disposed inside the apparatus main body 100A includes: a development bias controller 57; a control value determining portion 56; a DC/AC correction ratio table 55; a DC/AC correction voltage table 53; and a control value calculating portion 54. The control value calculating portion 54 is connected to the applied amount controller 51. The DC/AC correction ratio table 55 and the DC/AC correction voltage table 53 are connected to the control value calculating portion 54. In addition, the control value determining portion 56 is connected to the DC/AC correction ratio table 55 and the DC/AC correction voltage table 53. The development bias controller 57 is connected to the control value determining portion 56. In addition, the electric potential measuring device 50 is connected between the applied amount controller 51 and the control value calculating portion 54.

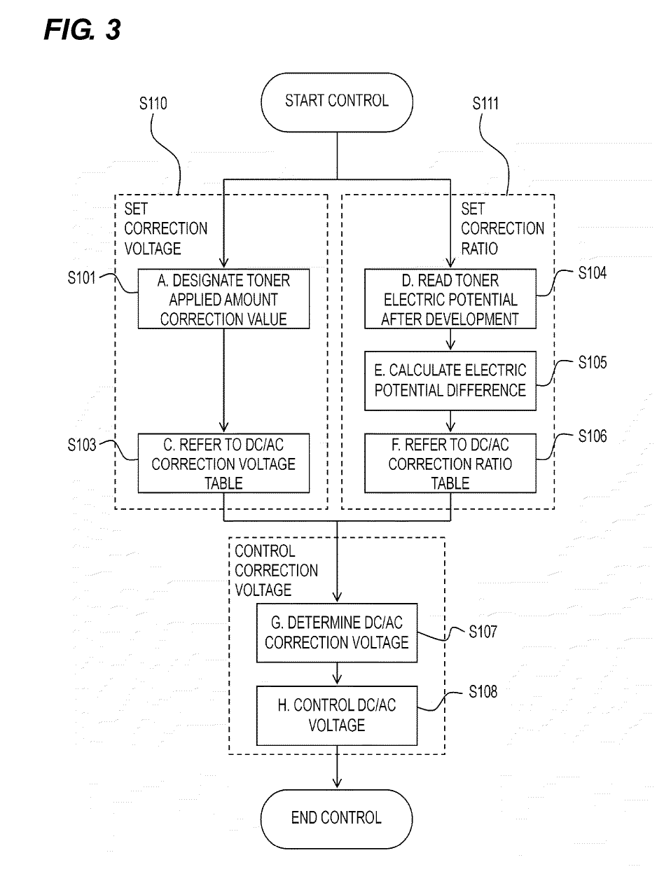

FIG. 3 is a flowchart that illustrates the control process of the controller 500. As illustrated in FIG. 3, the controller 500 executes setting of a correction voltage (step 110; hereinafter, a “step” will be simply referred to as “S”) (S110) and setting of a correction ratio (S111) according to the start of the control process. Here, S110 includes S101 and S103 to be described later, and S111 includes S104 to S106 to be described later. Hereinafter, after the setting of a correction voltage is described, the setting of a correction ratio will be described. In Embodiment 1, featured portions of the present invention are described in S111 in FIG. 3 and are described in fields of the correction ratios of the development DC bias and the development AC bias illustrated in FIG. 4B in FIG. 4.

### (Correction Voltage Calculation) (Calculation of Correction Voltage Changing According to Type of Sheet (Toner Applied Amount))

First, the setting of a correction voltage (S110) will be described. It is assumed that a coated sheet is housed in the cassette J1 and a rough sheet is housed in the cassette J2. The applied amount controller 51 acquires the type of a recording material for which image formation is executed by using the type sensors 181 and 182 as acquisition portions. Then, based on detection results acquired by the type sensors 181 and 182 of the cassettes J1 and J2, information relating to a toner applied amount corresponding to the detected type (for example, the coated sheet or the rough sheet) of the recording material is determined.

It is assumed that the user changes the sheet from the coated sheet printed at the previous time to the rough sheet desired to be printed next time by using the setting portion 500B. The applied amount controller 51 transmits a change from the cassette J1 for which the type sensor 181 detects a coated sheet to the cassette J2 for which the type sensor 182 detects a rough sheet and the toner applied amounts of the coated sheet and the rough sheet to the control value calculating portion 54.

Then, the control value calculating portion 54 receives a control signal indicating a change from the coated sheet to the rough sheet from the applied amount controller 51. The control value calculating portion 54 calculates an applied amount correction value ΔM/S=+0.10 mg/cm² that is a difference when a toner applied amount of 0.45 mg/cm² that is necessary for the coated sheet is changed to a toner applied amount of 0.55 mg/cm² that is necessary for the rough sheet (S101).

To the contrary, when the user changes the sheet from the rough sheet to the coated sheet by using the setting portion 500B, the applied amount controller 51 transmits a change from the cassette J2 of the rough sheet to the cassette J1 of the coated sheet and the toner applied amounts of the coated sheet and the rough sheet to the control value calculating portion 54.

Then, the control value calculating portion 54 receives a control signal indicating a change from the rough sheet to the coated sheet from the applied amount controller 51. The control value calculating portion 54 calculates an applied amount correction value ΔM/S=−0.10 mg/cm² that is a difference when the toner applied amount of 0.55 mg/cm² that is necessary for the rough sheet is changed to the toner applied amount of 0.45 mg/cm² that is necessary for the coated sheet (S101). The controller 500 refers to the DC/AC correction voltage table 53 (to be described later in detail with reference to FIG. 4A) stored in the memory of the calculation portion 52 for the applied amount correction value (S103).

Here, the DC/AC correction voltage table 53 is a table that represents a correction value of the development DC bias when only the development DC bias is changed in a state of good developability and a correction value of the development AC bias when only the development AC bias is changed in a state of bad developability.

FIG. 4A is the DC/AC correction voltage table. The DC/AC correction voltage table is recorded in the controller 550 in advance. FIG. 4A illustrates relation among the applied amount correction value ΔM/S, the change amount ΔVcont of the DC bias, and the change amount ΔVpp of the development AC bias. In this embodiment, the applied amount correction value ΔM/S is the amount of change of a target density of toner that is necessary for printing data onto the sheet P. For example, in the meaning of initially setting a target density to a toner applied amount that is necessary for the coated sheet and resetting the target density to the toner applied amount that is necessary for the rough sheet, the applied amount correction value represents the amount of change of the target density.

The controller 500 has data relating to a first value of the contrast electric potential (development contrast Vcont) that is an electric potential difference between the image portion electric potential VI of the photosensitive drum 201, which is set in advance according to a change amount of the target density corresponding to a difference between the target density (for example, the target density of the next rough sheet that is detected by the type sensor 182) set by the setting portion 500B and a detection result (for example, the target density of the coated sheet that is initially set based on the type sensor 181) acquired by the density sensor, and the development DC bias Vdc and a second value of the development AC bias.

Here, in the case of S110 represented in FIG. 3, since the applied amount correction value ΔM/S is +0.10 mg/cm², the controller 500 sets the development DC bias=+57 V and the development AC bias=+200 V as correction voltages of the development DC/AC biases.

In addition, contrary to this, in the case of S110 represented in FIG. 3, in a case where the applied amount correction value ΔM/S is −0.10 mg/cm², the controller 500 sets the development DC bias=−57 V and the development AC bias=−200 V as correction voltages of the development DC/AC biases. When the applied correction value is negative, the correction voltages of the development DC/AC biases have negative values in the table.

Here, a method of generating the DC/AC correction voltage table 53 illustrated in FIG. 4A will be described. Here, bias setting values that are necessary for changing each toner applied amount ΔM/S are acquired for the initial state of the developer having good developability and a degraded state of the developer having bad developability.

In the initial state of the developer, the developability is good, and the controller 500 changes the toner applied amounts by using only the development DC bias. Thus, change values of the development DC bias that are necessary for changing the toner applied amounts of a case where the applied amount correction values ΔM/S are 0.00 mg/cm², 0.05 mg/cm², 0.10 mg/cm², 0.15 mg/cm², and 0.20 mg/cm² are acquired.

In the degraded state of the developer, the developability is bad, and the controller 500 changes the toner applied amounts by using the development AC bias. Thus, change values of the development AC bias that are necessary for changing the toner applied amounts of a case where the applied amount correction values ΔM/S are 0.00 mg/cm², 0.05 mg/cm², 0.10 mg/cm², 0.15 mg/cm², and 0.20 mg/cm² are acquired.

As described above, in a case where the sheet type is the coated sheet, the applied amount is 0.45 mg/cm² (current value), and, in a case where the sheet type is the rough sheet, the applied amount is 0.55 mg/cm² (target value). Thus, when the used sheet is changed from the coated sheet to the rough sheet, the applied amount correction value ΔM/S=+0.10 mg/cm².

For these reasons, the controller 500 can be regarded to control the calculation of correction voltages as below. The controller 500 includes a setting portion 500B that sets one of a plurality of cassettes J1 and J2 to be used.

The controller 500 receives a first target toner applied amount that is stored in relation with the sheet of the (first) cassette J1 among the plurality of cassettes set by the setting portion 500B and a second target toner applied amount that is stored in relation with the sheet of the (second) cassette J2. The controller 500 controls the contrast electric potential that is an electric potential difference between the image portion electric potential of the photosensitive drum 201 and the development DC bias and the development AC bias based on the first target toner applied amount and the second target toner applied amount. In addition, in Embodiment 1, the controller 500 changes the contrast electric potential by changing the development DC bias.

In other words, when the current sheet P (coated sheet) of the cassette J1 is switched to the next sheet P (rough sheet) of the cassette J2 by the setting portion 500B, the controller 500 executes the following control process. The controller 500 calculates an applied amount correction amount (+0.10 mg/cm²) that is acquired by subtracting the first target applied amount (for example, 0.45 mg/cm²) of the coated sheet from the second target applied amount (for example, 0.55 mg/cm²) of the rough sheet.

As such an applied amount correction amount is larger (for example, in the case of 0.20 mg/cm² with respect to the case of 0.10 mg/cm²), the controller 500 sets the development contrast (contrast electric potential) and the development AC bias to be larger. For example, the controller 500 sets the development DC bias from 57 V to 116 V and sets the development AC bias from 200 V to 400 V.

### (Calculation of Correction Ratio) (Calculation of Correction Ratio Changing Based on Initial Period/Degradation of Toner)

The controller 500, in a state in which the toner electric potential of the photosensitive drum 201 is read, charges the charging electric potential of the surface of the photosensitive drum 201 to −500 V, charges the electric potential of the exposure portion of the surface of the photosensitive drum 201 to −150 V, and sets the development DC bias to −350 V. Accordingly, the development contrast Vcont is 200 V. Here, when the controller 500 reads the toner electric potential Vtoner, a case will be described as an example in which the measurement is executed at constant development contrast (for example, 200 V described above).

In addition, here, a case will be described as an example in which the toner electric potential is −350 V in the initial state and is −300 V in the degraded state. Here, while the DC correction ratio and the AC correction ratio are derived in the condition of the same electric potential as that at the time of forming an image as described above, the numerical values may be appropriately changed.

The controller 500 reads the toner electric potential Vtoner of the photosensitive drum 201 by using the electric potential measuring device 50 arranged on the downstream side in the rotation direction of the photosensitive drum 201 (S104). A plurality of timings for the reading process is considered as below. For example, the timing is every time after 10,000 sheets are printed. Alternatively, the timing is a time when the coated sheet is switched to the rough sheet. In such a case, the controller 500 may be configured to read the toner electric potential of the photosensitive drum 201 and executes the control process according to the present invention.

In addition, in a case where sheets in which a rough sheet is inserted for every 100 sheets out of 1,000 coated sheets are to be printed, the controller 500 may be configured to execute the control process according to this embodiment when the coated sheet is switched to the rough sheet. Furthermore, in a case where the power of the image forming apparatus 100 is input, it may be configured such that the toner electric potential is read, and the control process according to this embodiment is executed (this last example will be described again in Embodiment 5).

The controller 500 acquires an electric potential difference (charging electric potential difference) between the toner electric potential Vtoner of the photosensitive drum 201 and the set value −350 V of the development DC bias Vdc by using the control value calculating portion 54 (S105). The controller 500 refers to the DC/AC correction ratio table 55 (to be described later in detail with reference to FIG. 4B) based on the electric potential difference (charging electric potential difference) (S106).

Here, the DC/AC correction ratio table 55 is a table that represents correction ratios of the development DC bias and the development AC bias according to an electric potential difference (charging electric potential difference) between the toner electric potential Vtoner after development and the development DC bias Vdc. Here, the correction ratios of the development DC bias and the development AC bias are adjusted according to the quality level of the developability.

In this table, at the charging electric potential difference of 0 V, the toner corresponds to the initial state. On the other hand, at the charging electric potential difference of 50 V that is the maximal, the toner corresponds to the degraded state. In addition, the numerical values are recorded in the controller 500 such that the toner is closer to the initial state as the charging electric potential difference is closer to 0 V, and the toner is closer to the degraded state as the charging electric potential difference is closer to 50 V.

The “DC correction ratio” is a ratio by which the DC bias correction value is multiplied as a numerical value closer to 100% as the charging electric potential difference is in the state of being closer to 0 V (as the toner in the state of being closer to the initial state). In addition, the “AC correction ratio” is a ratio by which the AC bias correction value is multiplied as a numerical value closer to 100% as the charging electric potential difference is in the state of being closer to the maximal value (as the toner is in the state of being closer to the degraded state).

When the charging electric potential difference is 0 V, as described above, the “toner is in the initial state” as described above, and thus, the DC correction ratio is set to 100%, and the AC correction ratio is set to 0%. Accordingly, the controller 500 multiplies the DC bias correction value based on the applied amount correction value described above by the DC correction ratio 100% and uses 100% of the DC bias correction value. In addition, the controller 500 multiplies the AC bias correction value based on the applied amount correction value described above by the AC correction ratio 0% and uses 0% of the AC bias correction value (in other words, the AC bias correction value is not used).

Accordingly, when the “toner is in the initial state”, the controller 500 uses 100% of the DC bias correction value according to the applied amount correction value and sets the AC bias correction value according to the applied amount correction value to “0”.

When the charging electric potential difference is 50 V, as described above, the “toner is in the degraded state” as described above, and thus, the DC correction ratio is set to 0%, and the AC correction ratio is set to 100%. Accordingly, the controller 500 multiplies the DC bias correction value based on the applied amount correction value described above by the DC correction ratio 0% and uses 0% of the DC bias correction value (in other words, the DC bias correction value is not used). In addition, the controller 500 multiplies the AC bias correction value based on the applied amount correction value described above by the AC correction ratio 100% and uses 100% of the AC bias correction value.

Accordingly, when the “toner is in the degraded state”, the controller 500 uses 100% of the AC bias correction value according to the applied amount correction value with the DC bias correction value according to the applied amount correction value being set to “0”. Hereinafter, an example of specific numerical values will be described.

FIG. 4B is not a table in which a sum of the DC correction ratio and the AC correction ratio is determined to necessarily be 100% at a predetermined charging electric potential difference. For example, in a case where the charging electric potential difference is 20 V, it is not determined that a sum of the DC correction ratio 80% and the AC correction ratio 20% is necessarily 100%. Depending on data, in the case where the charging electric potential difference is 20 V, there are also cases where the DC correction ratio is 82%, and the AC correction ratio is 22%. Each of numerical values of the DC correction ratio and the AC correction ratio corresponds to the charging electric potential difference, but the DC correction ratio and the AC correction ratio do not correspond to each other.

The controller 500, in correspondence with a charging electric potential difference between the development DC bias set when a toner image for control is formed and the electric potential of the toner image for control, has data relating to the DC correction ratio of the contrast electric potential (development contrast Vcont) that is an electric potential difference between the image portion electric potential VI of the photosensitive drum 201 and the development DC bias Vdc and the AC correction ratio of the development AC bias. Such data has relation in which, with respect to the charging electric potential difference of a first predetermined value (the initial state or a state side close thereto), for the charging electric potential difference of a second predetermined value larger than the first predetermined value, the DC correction ratio is smaller, and the AC correction ratio is larger.

For example, as illustrated in FIG. 4B, with respect to a charging electric potential difference, for example, of 20 V corresponding to the first predetermined value, for a charging electric potential difference, for example, of 50 V corresponding to the second predetermined value, the DC correction ratio decreases from 60% to 0%, and the AC correction ratio increases from 40% to 100%.

For these reasons, for example, when the charging electric potential difference is 20 V as the first predetermined value, the first contrast electric potential is set by using a DC correction ratio of 60%, and the first AC bias is set by using an AC correction ratio of 40%. When the charging electric potential difference is 50 V as the second predetermined value, the second contrast electric potential is set by using a DC correction ratio of 0%, and the second AC bias is set by using an AC correction ratio of 100%. Therefore the controller decreases the development contrast, and increases the AC bias, when a charging electric potential difference, which is a potential difference between a potential of a predetermined toner image developed by the development device on the image bearing member and the DC bias applied to the development device when the predetermined toner image is developed, increases from a first predetermined value to a second predetermined value. And the controller increases a ratio of the AC bias to the development contrast, when a charging electric potential difference, which is potential difference between potential of a predetermined toner image developed by the development device on the image bearing member and the DC bias applied to the development device when the predetermined toner image is developed, increases from a first predetermined value to a second predetermined value;

In other words, a case where the ratio of the AC bias to the contrast electric potential set during image formation is a first ratio in the case of the first predetermined value and a case where the ratio of the AC bias to the contrast electric potential set during image formation in the case of the second predetermined value is a second ratio will be described. In such a case, the second ratio can be regarded to be higher than the first ratio.

For example, in a case where an electric potential difference between the toner electric potential Vtoner after development of −300 V and the development DC bias Vdc of −350 V is 50 V, and a “level of bad developability” is determined, the process is as below. By using the DC/AC correction ratio table illustrated in FIG. 4B, the correction ratio of the DC bias is set to 0%, and the correction ratio of the AC bias is set to 100%.

FIG. 4B is the DC/AC correction ratio table. The DC/AC correction ratio table is recorded in the controller 500 in advance. FIG. 4B illustrates relation among the charging electric potential difference V, the correction ratio (DC correction ratio) of the development DC bias Vcont, and the correction ratio (AC correction ratio) of the development AC bias Vpp. For example, in a case where the charging electric potential difference is 20 V, the controller 500 sets the DC correction ratio to 60% and sets the AC correction ratio to 40%.

Here, a method of generating the DC/AC correction ratio table 55 illustrated in FIG. 4B will be described. An electric potential difference between the toner electric potential Vtoner after development and the development DC bias Vdc is acquired in the degraded state, and, at the time of the electric potential difference, the change ratio of the development AC bias is set to 100%, and the change ratio of the development DC bias is set to 0%.

In this embodiment, a case will be considered in which an electric potential difference between the toner electric potential Vtoner after development and the development DC bias Vdc is 50 V in the degraded state. At this time, the controller 500 executes the control process by using only the development AC bias. In other words, the controller 500 executes the control process such that the control ratio of the development DC bias is 0%, and the control ratio of the development AC bias is 100%.

A case will be considered in which an electric potential difference between the toner electric potential Vtoner after development and the development DC bias Vdc is 0 V in the initial state. At this time, the controller 500 executes the control process by using only the development DC bias. In other words, the controller 500 executes the control process such that the control ratio of the development DC bias is 100%, and the control ratio of the development AC bias is 0%.

When the setting is changed from the cassette J1 of the coated sheet to the cassette J2 of the rough sheet, the controller 500 executes the control process as below. The controller 500 changes the correction ratio of a second value of the development AC bias to be higher in a case where a difference between the development DC bias and the toner electric potential is the second predetermined value (for example, 50 V), which is larger than a first predetermined value, than in a case where the difference is the first predetermined value (for example, 20 V). For example, the controller 500 changes the correction ratio of the second value of the development AC bias from 40% to 100%.

When the setting is changed from the cassette J1 of the coated sheet to the cassette J2 of the rough sheet described above, the controller 500 executes the control process as below. The controller 500 changes the correction ratio of a first value of the development contrast (contrast electric potential) to be lower in a case where a difference between the development DC bias and the toner electric potential is a second predetermined value (for example, 50 V), which is larger than the first predetermined value, than in a case where the difference is the first predetermined value (for example, 20 V). For example, the controller 500 changes the correction ratio of the first value of the development contrast (contrast electric potential) from 40% to 0%.

In this embodiment, an electric potential difference between the toner electric potential Vtoner after development and the development DC bias Vdc is 0 V in the initial state. However, also in a case where the electric potential difference between the toner electric potential Vtoner after development and the development DC bias Vdc is not 0 V in the initial state of the developer, the correction ratio of the development DC bias may be set to 100%. In other words, in FIG. 4B, when the charging electric potential difference is 10 V, 20 V, 30 V, 40 V, or 50 V other than 0 V, the correction ratio of the development DC bias may be set to 100%. As above, by not changing the correction ratio of the development DC bias, the correction ratio of the development contrast (contrast electric potential) may not be changed (configured to be stationary).

Based on the “DC/AC correction voltage table” and the “DC/AC correction ratio table” acquired by the operation described above, by using the developer of which the degradation level is changed, the matching between an electric potential difference between the toner electric potential Vtoner after development and the development DC bias Vdc and the correction table is checked, and fine adjustment is executed.

In other words, the controller 500 executes control to cause the development device 209 to execute development by using a development AC bias after addition that is acquired by adding the value of the development AC bias of the initial condition of the toner and the value of the correction amount of the development AC bias, which is acquired by multiplying the second value of the development AC bias by the correction ratio, as an AC bias during image formation. In addition, the controller 500 executes control to cause the development device 209 to execute development by using a development DC bias (contrast electric potential) after addition that is acquired by adding the value of the development DC bias (contrast electric potential) of the initial condition of the toner and the value of the correction amount of the development DC bias (contrast electric potential), which is acquired by multiplying the first value of the development DC bias (contrast electric potential) by the correction ratio, as contrast electric potential during image formation. In addition, the initial condition can be regarded as a condition of a case where an electric potential difference between the development DC bias and the toner electric potential is “0”.

This will be described by referring back to FIG. 3. The control value determining portion 56 of the controller 500 determines final correction voltage values (final correction voltages) of the development DC bias and the development AC bias by multiplying the “correction voltages” by the “correction ratios” (S107). Here, the correction amount of the development DC bias is 57 V×0%=0 V, and the correction amount of the development AC bias is 200 V×100%=200 V.

The development bias controller 57 of the controller 500 sets the development DC bias to (350+0=) 350 V acquired by adding the correction amount of 0 V to the initial condition of 350 V based on the determined correction amount. In this way, the contrast electric potential is set. In addition, the development bias controller 57 sets the development AC bias to (1200+200=) 1400 V acquired by adding the correction amount of 200 V to the initial condition of 1200 V based on the determined correction amount. In this way, the AC bias is set. Then, the controller 500 controls a DC bias power supply 58 (bias applying portion) (see FIG. 2) and an AC bias power supply 59 (bias applying portion) (see FIG. 2) through the development bias controller 57 (S108). In this way, the correction of a desired toner applied amount is realized.

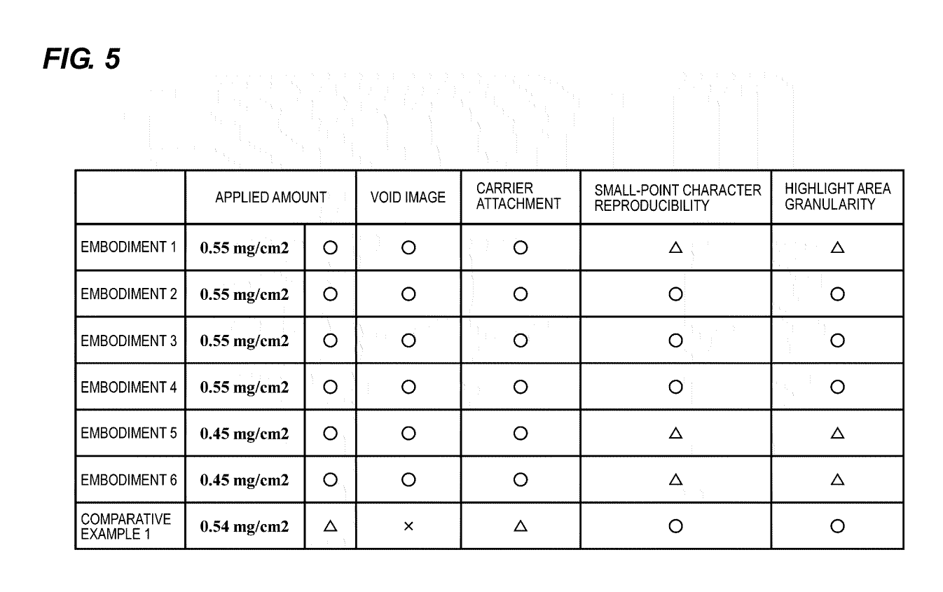

FIG. 5 is a table in which good (◯), O.K. (Δ), or bad (x) is determined for each of an applied amount, a void image, carrier attachment, small-point character reproducibility, and highlight area granularity. As can be understood from FIG. 5, together with realizing a desired toner applied amount of 0.55 mg/cm², a good output image not having a void image, carrier attachment, and the like can be acquired.

### Embodiment 2

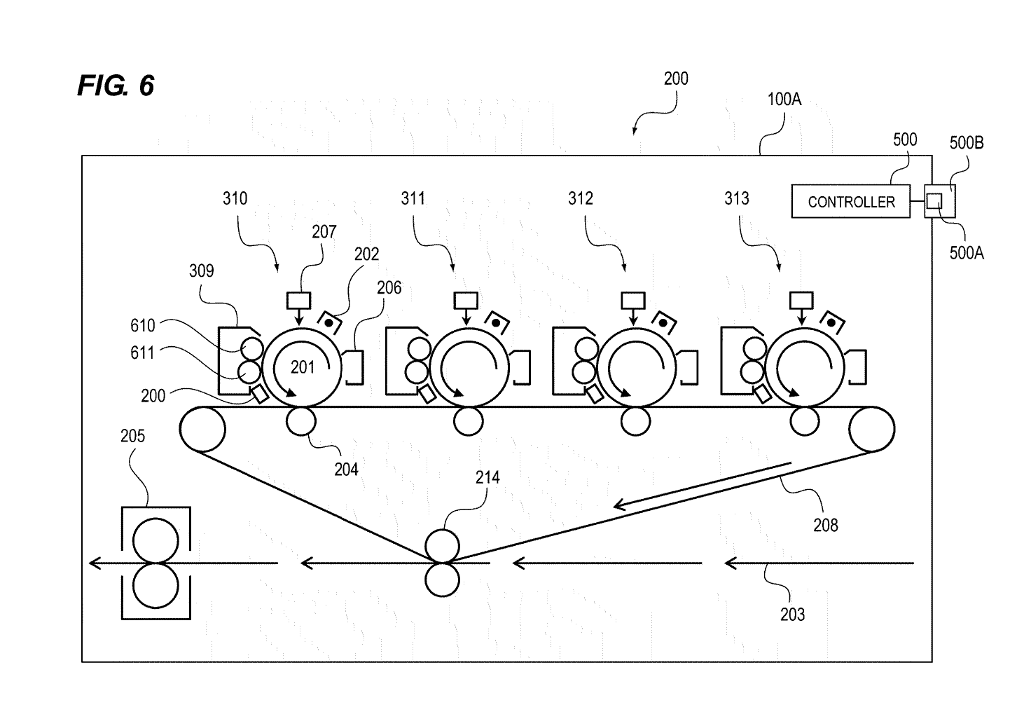

FIG. 6 is a cross-sectional view of an image forming apparatus 200 according to Embodiment 2. Among the configurations of Embodiment 2, the same reference numeral is assigned to each of the same configuration as that of Embodiment 1, and description thereof will not be presented. As illustrated in FIG. 6, the image forming apparatus 200 includes an apparatus main body 100A, and, inside the apparatus main body 100A, a development device 309 is arranged.

The development device 309 includes a plurality of (here, two) development sleeves 610 and 611 that can independently control the development bias as “developer bearing members”. The controller 500 changes a development bias of the development sleeve 610 located on the uppermost stream in the rotation direction of a photosensitive drum 201. In this way, in Embodiment 2, by applying a control process similar to that of Embodiment 1 to the upstream-side development sleeve 610 out of the two development sleeves 610 and 611, the control of an applied amount and the point character reproduction and the highlight granularity can be realized together.

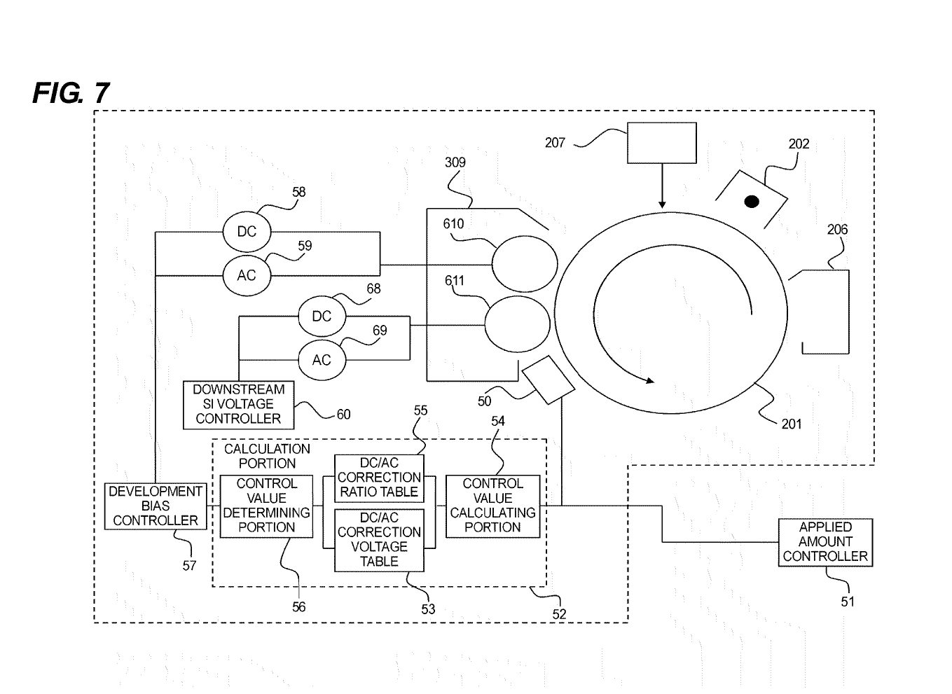

FIG. 7 is a block diagram of a controller 500. In this embodiment, since a bias control process for the downstream-side development sleeve 611 that is executed by a voltage controller 60 is executed as an ordinary control process, the voltage controller 60 of the downstream-side development sleeve 611 is configured not to receive a correction signal from a calculation portion 52. The other configurations are similar to those of Embodiment 1 described with reference to FIG. 2.

The control process similar to that of Embodiment 1 is executed by using the configurations described above, and the applied amount is corrected by the upstream-side development sleeve 610. More specifically, a development DC bias of 350 V and a development AC bias of 1400 V are applied, and, by applying a development DC bias of 350 V and a development AC bias of 1200 V, which are initial settings, to the downstream-side development sleeve 611, an image is output.

A result is illustrated in the table of FIG. 5. As can be understood from the table, similar to Embodiment 1, a toner applied amount of 0.55 mg/cm² is realized, and a good image having no void image and no carrier attachment is acquired. In addition, since the development bias applied to the downstream-side development sleeve 611 is the same condition as that of the initial period, and the image characteristics are good, good results are acquired also for the granularity of a highlight area, the reproducibility of a small-point character, and the like.

When the development AC bias is increased too much so as to increase the toner applied amount, toner disposed in highlight to halftone areas is peeled off according to a strong electric field, and the reproducibility of a small-point character and highlight to halftone is degraded. In Embodiment 1, since the development AC bias is set to be high, the reproducibility of a small-point character and a highlight area is slightly degraded. In contrast to this, in this embodiment, since the development bias of the downstream-side development sleeve 611 is not changed, the applied amount can be corrected without degrading the reproducibility of a small-point character and a highlight area.

In the description presented above, the controller 500 changes the development bias of the development sleeve 610 disposed on the upstream side in the direction of movement of the photosensitive drum 201 but does not change the development bias of the development sleeve 611 disposed on the downstream side in the direction of movement of the photosensitive drum 201. This may be changed as below. The controller 500 may set the amount of change of the development bias of the development sleeve 610 located on the upstream side in the rotation direction of the photosensitive drum 201 to be larger than that of the development bias of the development sleeve 611 located on the downstream side in the rotation direction of the photosensitive drum 201.

### Embodiment 3

In Embodiments 1 and 2, in the DC/AC correction ratio table, while the controlled ratios of the development DC bias and the development AC bias are configured to be changed in a stepwise manner, the controlled ratios are continuously changed in Embodiment 3.

More specifically, a targeted toner applied amount is 0.55 mg/cm², and the applied amount correction value ΔM/S is 0.10 mg/cm², which are similar to those of Embodiment 1, and the correction voltages of the DC/AC biases are set as DC=57 V, and AC=200 V.

Next, similar to Embodiment 1, the correction ratios of the DC/AC biases are set. In this embodiment, by linearly interpolating the values of 20 V and 30 V included in the DC/AC bias correction ratio table illustrated in FIG. 4B, the correction ratio is acquired. For example, a case will be described in which an electric potential difference between the toner electric potential Vtoner after development and the development DC bias Vdc is 25 V. In such a case, as a result of linearly interpolating the values of 20 V and 30 V included in the DC/AC bias correction ratio table illustrated in FIG. 4B, the correction ratio of the DC bias is set to 50%, and the correction ratio of the AC bias is set to 50%.

For the correction voltage and the correction ratio acquired in the process described above, the correction voltage is multiplied by the correction ratio by the control value determining portion 56, and the correction amount of the development DC bias is determined to be 57 V×50%=29 V, and the correction amount of the development AC bias is determined to be 200 V×50%=100 V. By adding the determined correction amounts to the initial set values, the development DC bias is set to 350+29=379 V, and the development AC bias is set to 1200+100=1300 V. By using these, a development DC bias of 379 V and a development AC bias of 1300 V are applied to the upstream-side development sleeve 610 through the development bias controller 57. In addition, a development DC bias of 350 V and a development AC bias of 1200 V, which are the same as those of the initial settings, are applied to the downstream-side development sleeve 611.

A result of thereof is illustrated in the table of FIG. 5. As can be understood from the table, similar to Embodiment 2, a toner applied amount of 0.55 mg/cm² is realized, and a good image having no void image and no carrier attachment is acquired. In addition, since the development bias applied to the downstream-side development sleeve 611 is an ordinary setting, similar to Embodiment 2, good results are acquired also for the granularity of a highlight area, the reproducibility of a small-point character, and the like.

### Embodiment 4

In Embodiment 4, the control of the development contrast Vcont is executed by adjusting exposure portion electric potential Vl.

More specifically, in a case where an applied amount correction value ΔM/S is 0.10 mg/cm², similarly to Embodiment 1, as the DC/AC correction voltages, DC (Vcont)=57 V, and AC=200 V are set. In addition, the correction ratios of the DC/AC biases are set. In this embodiment, since an electric potential difference between the toner electric potential Vtoner after development and the development DC bias Vdc is 10 V, by referring to the value of 10 V included in the DC/AC correction ratio table illustrated in FIG. 4B, the correction ratio of the DC bias is determined to be 80%, and the correction ratio of the AC bias is determined to be 20%.

For the correction voltage and the correction ratio acquired in the process described above, the correction voltage is multiplied by the correction ratio by the control value determining portion 56, and the correction amount of the development DC bias is determined to be 57 V×80%=45.6 V, and the correction amount of the development AC bias is determined to be 200 V×20%=40 V. In this embodiment, based on the determined correction amounts, the exposure portion electric potential is decreased by 45.6 V to be 104.4 V, the development DC bias is not changed to be 350 V, and the development AC bias is set to 1200+40=1240 V.

By using these, a development DC bias of 350 V and a development AC bias of 1240 V are applied to the upstream-side development sleeve 610 through the development bias controller 57. In addition, a development DC bias of 350 V and a development AC bias of 1200 V are applied to the downstream-side development sleeve 611, whereby an image is output.

A result of thereof is illustrated in the table of FIG. 5. As can be understood from the table, similar to Embodiment 3, a toner applied amount of 0.55 mg/cm² is realized, and no void image or no carrier attachment occurs, and, good results are acquired also for the granularity of a highlight area and the reproducibility of a small-point character.

### Embodiment 5

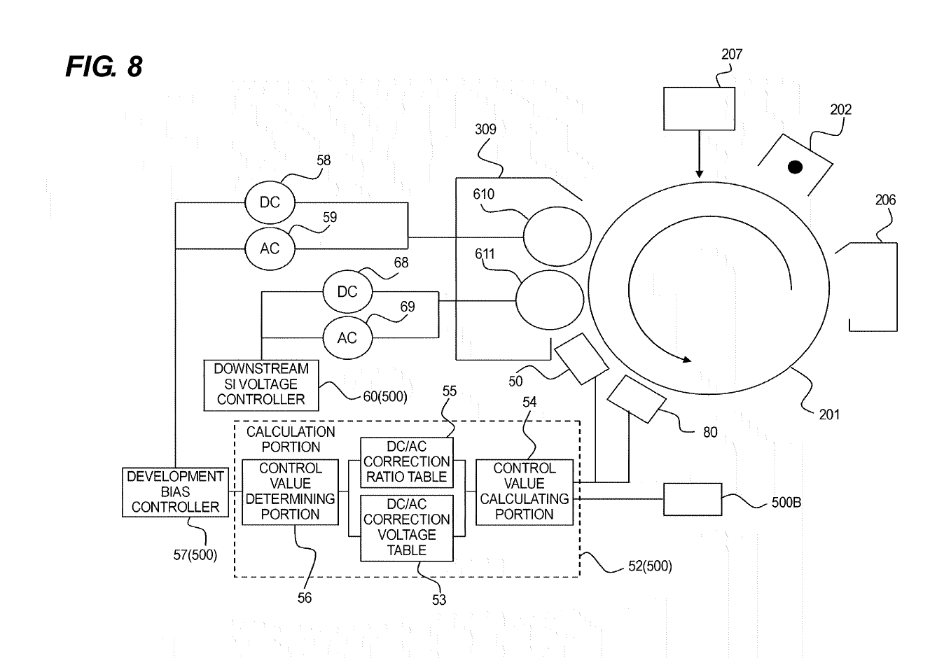

FIG. 8 is a block diagram of an image forming apparatus according to Embodiment 5. In Embodiment 5, in addition to the configuration of Embodiment 2, a toner applied amount of a photosensitive drum 201 is detected and is changed to a desired toner applied amount. The detection of the toner applied amount is executed by forming a toner image of a 2 cm square on the photosensitive drum 201, irradiating light such as an LED light thereto, reading only a specular reflection light quantity or a specular reflection light quantity and a diffused reflected light quantity using a light reception sensor, and calculating the density. In other words, this relates to patch detection.

As illustrated in FIG. 8, an applied amount sensor 80 (density sensor) detecting a toner applied amount is arranged on the downstream side of the development device 309 in the rotation direction of the photosensitive drum 201 that is denoted by an arrow. The applied amount sensor 80 is a sensor that is used for patch detection. The other configurations are similar to those of Embodiment 2 described with reference to FIG. 7.

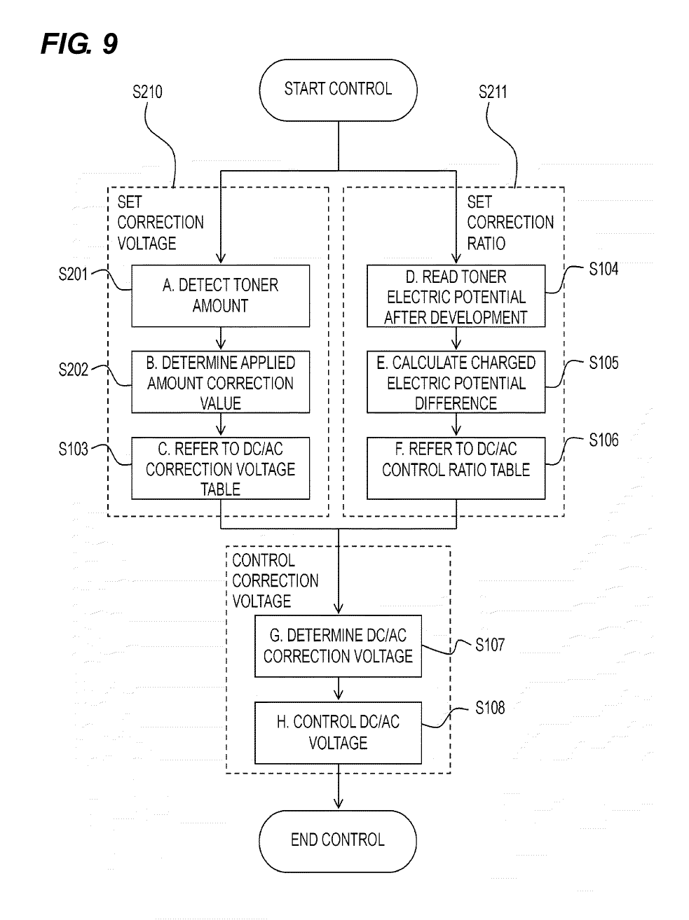

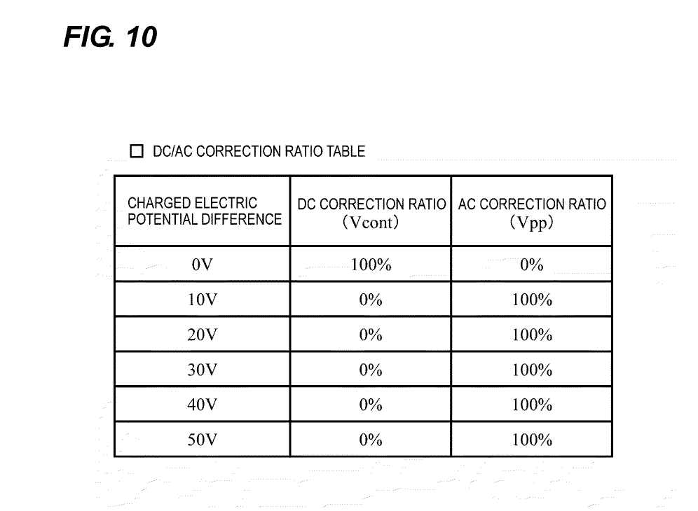

FIG. 9 is a flowchart that illustrates a control process of a controller 500. FIG. 10 is a DC/AC correction ratio table. As illustrated in FIG. 9, the controller 500 executes correction voltage setting (S210) and correction ratio setting (S211) together. S210 includes S201 to S103. S211 includes S104 to S106. Hereinafter, after the correction voltage setting is described, the correction ratio setting will be described. In Embodiment 5, a featured part of the present invention is described in S211 in FIG. 9 and is described in the fields of the correction ratios of the development DC bias and the development AC bias in FIG. 10.

At timing during image generation, a patch image used for control is formed on the photosensitive drum 201 under an image generation condition defined in advance. Then, a toner applied amount of the patch image for control that is disposed on the photosensitive drum 201 is detected by an applied amount sensor 80 (S201). The controller 500 determines a correction amount of the applied amount based on a difference between the detected toner applied amount and a desired toner applied amount (S202).

In this embodiment, for a desired toner applied amount of 0.45 mg/cm², a toner applied amount of 0.41 mg/cm² that is acquired by the applied amount sensor 80 is transmitted to a control value calculating portion 54 of the calculation portion 52, and an applied amount correction amount ΔM/S of 0.04 mg/cm² is calculated.

The controller 500 acquires DC/AC correction voltages by referring to a DC/AC correction voltage table 53 stored in the memory of the calculation portion 52 using the value (S103).

In this embodiment, as DC/AC correction voltages for an applied amount correction value ΔM/S of 0.04 mg/cm² illustrated in FIG. 4A, DC=23.2 V and AC=80 V are set. Since the applied amount correction value is not included in FIG. 4A, linear interpolation is executed.

The controller 500 reads the toner electric potential Vtoner after development by using an electric potential measuring device 50 arranged on the downstream side of the development device 309 in the rotation direction of the photosensitive drum 201 (S104). The controller 500 acquires an electric potential difference between the toner electric potential and the development DC bias Vdc (S105). The controller determines DC/AC correction balances (S106). In addition, in S201, in a case where the toner applied amount of the patch image for control that is formed on the photosensitive drum 201 and the desired toner applied amount coincide with each other, the controller 500 sets the development contrast and the correction amount of the development AC bias to zero and sets the development contrast at the time of image formation and the development AC bias to values determined in advance.

In this embodiment, an electric potential difference between the toner electric potential Vtoner after development and the development DC bias Vdc is 23.2 V. In this embodiment, the target toner applied amount is not changed from the initial condition. In other words, the toner constantly applies the patch with the same target toner applied amount from the initial period. Accordingly, by referring to the DC/AC correction ratio table illustrated in FIG. 10, when the charging electric potential difference is not 0 V, 100% of the correction according to the AC bias is executed.

For the correction voltage and the correction ratio acquired in the process as described above, the correction voltage is multiplied by the correction ratio by the control value determining portion 56 (S107), and the correction amount of the development DC bias is set to 23.2 V×0%=0 V, and the correction amount of the development AC bias is set to 80 V×100%=80 V. Based on the determined correction amount, by adding the initial condition of 1200 V and the correction amount of 80 V, the development AC bias is set to (1200+80=) 1280 V. Then, the controller 500 controls the DC bias power supply 58 and the AC bias power supply 59 through the development bias controller 57 (S108). Accordingly, a desired toner applied amount correction can be realized.

A result of thereof is illustrated in the table of FIG. 5. As can be understood from the table, a desired toner applied amount of 0.45 mg/cm² is realized, and a good output image not having a void image, carrier attachment, and the like is acquired.

### Modified Example of Embodiment 5

Hereinafter, other modified examples (a case where the image quality mode is changed, a case where the toner is degraded, and a case where the toner charging amount is changed) will be described. In describing the modified examples, the DC/AC correction ratio table illustrated in FIG. 4B will be used for description with being switched to a DC/AC correction ratio table illustrated in FIG. 10. In addition, S210 and S211 illustrated in FIG. 9 described above will be described. Also in these modified examples, the operations of S107 and S108 illustrated in FIG. 9 are similarly executed.

(Case where Image Quality Mode is Changed)

As cases where the image quality mode is changed, for example, there are a case where printing using a deep color is desired, a case where printing with a high image quality is desired, and a case where printing using a light color in an economy mode is desired. For example, an operator changes the current printing using a light color to next printing using a deep color by using the setting portion 500B. Then, the controller 500 recognizes switching from a light color mode to a deep color mode.

The control value calculating portion 54 receives a current toner applied amount 0.45 mg/cm² (current value) of the light color that is detected by an applied amount sensor 80 and receives information of a next toner applied amount of 0.55 mg/cm² (target value) of the deep color that is set by the setting portion 500B. The control value calculating portion 54 calculates an applied amount correction value ΔM/S=+0.10 mg/cm² that is a difference when the toner applied amount of the current value is switched to the toner applied amount of a target value. Then, as described above with reference to FIG. 4A, the control value calculating portion 54 sets a development DC bias and first and second values of the development AC bias corresponding to the applied amount correction amount (corresponding to S210).

In other words, in a case where a toner applied amount of 0.45 mg/cm² of the patch density that is a criterion corresponding to the toner applied amount 0.55 mg/cm² of the target density is detected, the controller 500 calculates an applied amount correction value ΔM/S=+0.10 mg/cm² of a ΔDC bias (ΔVcont) and a ΔAC bias (ΔVpp). In addition, the relation (the content illustrated in FIG. 4A) of the ΔDC bias and the ΔAC bias corresponding to the applied amount correction value ΔM/S is stored in a memory.

Then, in a case where the target density and the patch density coincide with each other, the controller 500 calculates an applied amount correction value ΔM/S=+0.00 mg/cm² of the ΔDC bias (ΔVcont) and the ΔAC bias (ΔVpp). The relation (the content illustrated in FIG. 4A) of the ΔDC bias and the ΔAC bias corresponding to this applied amount correction value ΔM/S is stored in a memory.

At the same time, as described above with reference to FIG. 4B, the control value calculating portion 54 sets the correction ratios of the first and second values of the development DC bias and the development AC bias based on a difference between the toner electric potential measured by the electric potential measuring device 50 and the development bias (corresponding to S211). The relation (the content illustrated in FIG. 4B) among the charging electric potential difference and the DC correction ratio Vcont and the AC correction ratio Vpp is stored in a memory.

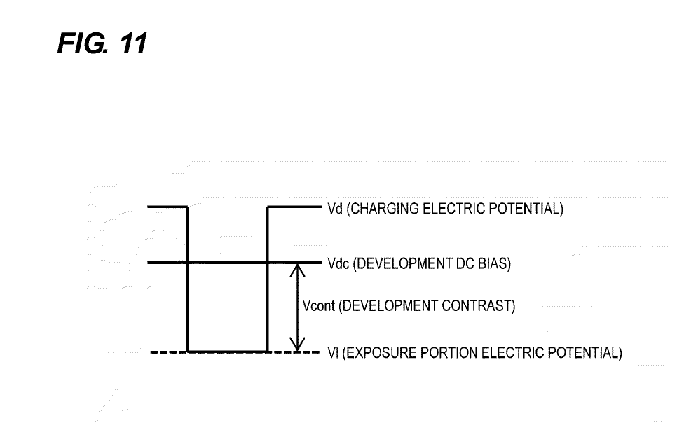

In addition, in a case where a voltage is applied for aiming for a specific development DC bias or a specific development AC bias by changing the target in a case where a toner image for patch detection is formed, the development contrast that is a difference between the development DC bias and the image portion electric potential is changed as well. In other words, in a case where a high-density patch or a low-density patch is applied, there are cases where the development DC bias or the exposure portion electric potential illustrated in FIG. 11 is changed, and, in such cases, the development contrast is changed.

For this reason, the charging electric potential difference corresponding to the DC correction ratio and the AC correction ratio that can occur within the range of the development contrast may be changed. In other words, in a case where a thick patch is applied, as the development contrast increases, a maximum value of 50 V of the charging electric potential difference illustrated in FIG. 4B, for example, further increases to 100 V. On the other hand, in a case where a thin patch is applied, as the development contrast decreases, a maximum value of 50 V of the charging electric potential difference illustrated in FIG. 4B, for example, decreases to 30 V. In this embodiment, a case is considered in which the toner electric potential is −350 V in the initial state and is −300 V in the degraded state.

However, here, in a state before the toner electric potential of the photosensitive drum 201 is read, the controller 500 sets the charging electric potential of the surface of the photosensitive drum 201 to −500 V and sets the electric potential of the exposure portion of the surface of the photosensitive drum 201 to −150 V, thereby executing setting for aiming for a development DC bias of −350 V. Accordingly, the development contrast Vcont is 200 V.

In addition, as the setting of the controller 500, the formation of a toner image for patch detection and the reading of the toner electric potential, for example, in this embodiment, may be executed at the time of inputting power of the image forming apparatus 100 or the like.

To sum up, the controller 500 executes the control process as below. The calculation portion 52 receives the target toner applied amount (target density) (for example, 0.55 mg/cm²) set by the setting portion 500B and the actually-measured toner applied amount (actually-measured density) (for example, 0.45 mg/cm²) that is a result of detection acquired by the applied amount sensor 80. The calculation portion 52 calculates an applied amount correction amount (difference) (for example, 0.10 mg/cm²) based on the target toner applied amount and the actually-measured toner applied amount.

The calculation portion 52 sets the change amount ΔVcont of the development contrast (contrast electric potential) and the change amount ΔVpp of the development AC bias based on the table illustrated in FIG. 4A to be larger in the case of a second applied amount difference (for example, 0.20 mg/cm²) larger than a first applied amount difference (for example, 0.10 mg/cm²) than in the case of the first applied amount difference (for example, the development DC bias is set from 57 V to 116 V, and the development AC bias is set from 200 V to 400 V).

At the same time, the calculation portion 52 sets the correction ratio of the correction amount of the development AC bias to be larger in a case where a difference between the set development DC bias and the toner electric potential is a second predetermined value (for example, 50 V) larger than a first predetermined value (for example, 20 V) than in a case where the difference is the first predetermined value. For example, the calculation portion 52 sets the correction ratio of the correction amount of the development AC bias to increase from 40% to 100%.

In addition, the calculation portion 52 sets the correction ratio of the correction amount of the development contrast (contrast electric potential) to be smaller in a case where a difference between the set development DC bias and the toner electric potential is a second predetermined value (for example, 50 V) larger than a first predetermined value (for example, 20 V) than in a case where the difference is the first predetermined value. For example, the calculation portion 52 sets the correction ratio of the correction amount of the development DC bias to decrease from 60% to 0%. In addition, the configurations of Embodiments 2 to 4 described above may be appropriately applied to the configuration of Embodiment 5 described above.

Then, at the time of the first predetermined value, the first contrast electric potential and the first AC bias are set, and, in a case where the detection result acquired by the applied amount sensor 80 (density sensor) and a predetermined target value are in the same condition, at the time of the second predetermined value, the second contrast electric potential and the second AC bias are set.

### Embodiment 6

In Embodiment 6, variations in toner triboelectricity are considered in Embodiment 5. Similar to Embodiment 5, a toner applied amount of the photosensitive drum 201 and the toner electric potential Vtoner after development are measured. This time, the toner applied amount is 0.38 mg/cm² (the applied amount correction amount=0.07 mg/cm²), and the charging electric potential difference is 20 V.

Compared to Embodiment 5 (the applied amount correction amount=0.04 mg/cm², and the charging electric potential difference is 20 V), while the charging electric potential difference is the same, the toner applied amount is decreased substantially. The predicted reason for this is that the charging amount of the toner is increased, and the toner electric potential after development with respect to the toner applied amount is increased. This suggests that, in order to develop 0.45 mg/cm² that is the target applied amount, the development contrast needs to be highly set. Thus, in this embodiment, the following calculation is executed by a calculation portion 52 that determines the correction DC value.

[Numerical Expression 1]

dDC=(Vtoner−Vl)/MS_dr*MS_target (1)

Here, Vtoner represents the measured development toner electric potential, Vl represents the exposure portion electric potential, MS_dr represents the measured toner applied amount of the drum, and MS_target represents the target toner applied amount.

This time, since Vtoner=330 V, Vl=150 V, MS_dr=0.38 mg/cm², and MS_target=0.45 mg/cm², a correction DC electric potential of “dDC=213 V” is acquired. Similar to Embodiment 5, since the applied amount correction amount=0.07 mg/cm², the correction amount of the AC component is acquired as AC=140 V based on FIG. 4A. By controlling the DC bias power supply 58 and the AC bias power supply 59 according to the acquired correction value, the correction of a desired toner applied amount can be realized.

A result thereof is illustrated in the table of FIG. 5. As can be understood from the table, the desired toner applied amount of 0.45 mg/cm² is realized, and a good output image not having a void image, carrier attachment, and the like can be acquired.

### Conventional Example

In a conventional example, in the control process of Embodiment 1, the correction of an applied amount is executed by only adjusting the development contrast Vconst by changing the exposure portion electric potential Vl. The toner applied amount after the change, similar to Embodiments 1 to 4, is 0.55 mg/cm², and the applied amount correction value is set to 0.10 mg/cm².

In this comparative example, while an electric potential difference between the toner electric potential Vtoner after development and the development DC bias Vdc is 50 V, and, similar to Embodiment 1, it can be regarded as a “state of bad developability”, the applied amount is controlled by only adjusting the development contrast Vcont. More specifically, the exposure portion electric potential is decreased from 150 V of the initial setting by 120 V to be 30 V, and an image is output by using a development DC bias of 350 V, a development AC bias of 1200 V, and the initial set values.

According to such setting, the development contrast is changed from 200 V that is the original value to 320 V after the correction. As a result of changing the development contrast, the applied amount is increased by 0.09 mg/cm² to be 0.54 mg/cm². Meanwhile, an electric potential difference between the toner electric potential Vtoner after development at this time and the development DC bias Vdc is 90 V, which is a value larger than 50 V before the applied amount correction.

A result thereof is illustrated in the table of FIG. 5. As can be understood from the table, the toner applied amount is not sufficiently corrected, but disadvantages occur due to a void image and carrier attachment.

As described above, the applicants of the present invention and the like have found that, in order to determine the quality of the developability of the apparatus, it is effective to use an electric potential difference between the toner electric potential Vtoner after development and the development DC bias Vdc as an index. When the electric potential difference between the toner electric potential Vtoner after development and the development DC bias Vdc is small, the development progresses up to desired toner electric potential, and the developability can be determined to be good. To the contrary, in a case where the electric potential difference between the toner electric potential Vtoner after development and the development DC bias Vdc is large, development does not progress up to a desired toner electric potential, and the developability can be determined to be bad.

Based on the determination of the quality of the developability as above, the development contrast is adjusted when the developability is good, and the development AC bias is adjusted when the developability is bad, whereby an appropriate toner applied amount can be controlled. In addition, since the degraded state of the developer changes in time, the quality level of the developability is determined each time, and, also for the control of the applied amount, it is more appropriate to change the control ratios of the development contrast and the development AC bias in a stepped manner based on the quality level.

The applicants of the present invention and the like have found that both the image characteristics and the applied amount can be achieved by correcting the toner applied amount using the upstream-side development sleeve in a development device using a plurality of development sleeves. According to reviews of the writer and the like, in a solid image area having high development contrast, toner developed by the upstream-side development sleeve is directly output without being changed also in the downstream-side development sleeve.

In contrast to this, in image areas of highlight to halftone in which the latent image electric potential is disposed on a further Vd side than Vdc, a toner image formed on the image bearing member that is developed by the upstream-side development sleeve enters the downstream-side development sleeve, and, finally, a toner image developed by a development sleeve of the lower-most stream side is output. Accordingly, the toner applied amount of the solid area may be controlled by using the upstream-side development sleeve, and the image characteristics of the highlight to halftone areas such as the reproduction of characters and the granularity of a halftone need to be controlled by using the downstream-side development sleeve.

As above, in a case where the applied amount is corrected by the development device using the plurality of development sleeves, the control process described above is executed by the upstream-side development sleeve, and it is appropriate to execute a control process focusing on the image characteristics by using the downstream-side development sleeve.

According to the present invention, also in a case where the developer is in a degraded state or a case where the developer is in the initial state, the contrast electric potential and the development AC bias can be set such that a toner applied amount better than that of the conventional case can be secured.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-143303, filed Jul. 11, 2014, which is hereby incorporated by reference herein in its entirety.

What is claimed is:

1. An image forming apparatus comprising:
an image bearing member which bears an image;
a development device which develops a latent image formed on the image bearing member;
a bias applying portion which applies a DC bias and an AC bias to the development device;
an electric potential sensor which detects electric potential of a toner image formed on the image bearing member;
a density sensor which acquires information relating to a density of the toner image; and
a controller configure to control a development contrast which is a potential difference between a potential of a image area on the image bearing member and the DC bias based on a result of the detection acquired by the density sensor, and control the AC bias based on the result of the detection acquired by the density sensor;
wherein said controller decreases the development contrast, and increases the AC bias, when a charging electric potential difference, which is a potential difference between a potential of a predetermined toner image developed by the development device on the image bearing member and the DC bias applied to the development device when the predetermined toner image is developed, increases from a first predetermined value to a second predetermined value;

2. The image forming apparatus according to claim 1, wherein the controller decreases the DC bias set at the time of image formation as the charging electric potential difference increases.

3. The image forming apparatus according to claim 1, wherein the controller increases the AC bias set at the time of image formation as the charging electric potential difference increases.

4. The image forming apparatus according to claim 1, further comprising
a setting portion which sets a target density at the time of image formation,
wherein the controller includes:
data relating to a first value of the development contrast and a second value of the AC bias which are set in advance according to a difference between a target density set by the setting portion and the result of the detection acquired by the density sensor; and
data which relates to a DC correction ratio and an AC correction ratio set in correspondence with the charging charging electric potential difference, and has relation in which the DC correction ratio is smaller and the AC correction ratio is larger for the charging electric potential difference of the second predetermined value, which is larger than the first predetermined value, than for the charging electric potential difference of the first predetermined value, and
wherein the controller controls the development contrast during image formation and the AC bias based on the development contrast acquired by multiplying the first value of the development contrast by the DC correction ratio and the AC bias acquired by multiplying the second value of the AC bias by the AC correction ratio.

5. The image forming apparatus according to claim 4, wherein the controller executes control of the development contrast and the AC bias such that the DC correction ratio of the development contrast is lower, and the AC correction ratio of the AC bias for the development contrast is higher in the case of the second predetermined value than in the case of the first predetermined value.

6. The image forming apparatus according to claim 4, wherein the controller executes control of the development contrast and the AC bias such that the AC correction ratio of the AC bias for the development contrast is higher in the case of the second predetermined value than in the case of the first predetermined value without changing the DC correction ratio of the development contrast.

7. The image forming apparatus according to claim 1, further comprising:
a plurality of cassettes each having a type sensor which determines a type of sheet; and
a setting portion which changes setting from a cassette used in the previous time to a cassette used next time among the plurality of cassettes,
wherein the controller, in a case where a result of detection acquired by the type sensor of the cassette used in the previous time and the type sensor of the cassette used next time are in the same condition, calculates a first value of the development contrast that is an charging electric potential difference between the image portion electric potential of the image bearing member and the DC bias and a second value of the AC bias based on a target density defined for a sheet of the cassette used in the next time, which is set by the setting portion, and a target density defined for a sheet of the cassette used in the previous time, calculates development contrast which is acquired by multiplying the correction amount of the development contrast by the DC correction ratio of the development contrast and an AC bias which is acquired by multiplying the correction amount of the AC bias by the AC correction ratio of the AC bias, and adds the calculated development contrast and the calculated AC bias to the development contrast and the AC bias of a time when an charging electric potential difference between the DC bias and the toner electric potential is zero.

8. The image forming apparatus according to claim 1,
wherein the development device includes a plurality of developer bearing members which can independently control the DC bias, and
wherein the controller changes a change amount of the DC bias of the developer bearing member located on an upstream side in a rotation direction of the image bearing member to be larger than a change amount of the DC bias of the developer bearing member located on a downstream side in the rotation direction of the image bearing member.

9. The image forming apparatus according to claim 1,
wherein the development device includes a plurality of developer bearing members which can independently control the DC bias, and
wherein the controller changes the DC bias of the developer bearing member located on an uppermost stream side in a rotation direction of the image bearing member.

10. The image forming apparatus according to claim 1, wherein the changing of the development contrast is executed by changing at least one of the DC bias and the image portion electric potential.

11. An image forming apparatus comprising:
an image bearing member which bears an image;
a development device which develops a latent image formed on the image bearing member;
a bias applying portion which applies a DC bias and an AC bias to the development device;
an electric potential sensor which detects electric potential of a toner image formed on the image bearing member;
a density sensor which acquires information relating to a density of the toner image; and
a controller configure to control a development contrast between potential of a image area on the image bearing member and the DC bias based on a result of the detection acquired by the density sensor, and control the AC bias based on the result of the detection acquired by the density sensor,
wherein said controller increases a ratio of the AC bias to the development contrast, when a charging electric potential difference, which is potential difference between potential of a predetermined toner image developed by the development device on the image bearing member and the DC bias applied to the development device when the predetermined toner image is developed, increases from a first predetermined value to a second predetermined value;
